(19) United States
(12) Patent Application Publication
(10) Pub. No.: US 2002/0117854 A1
(43) Pub. Date: Aug. 29, 2002

(54) Integrated compression sleeve

(76) Inventors: Anthony Constantine Thermos, Greer, SC (US); Benjamin Lynn Holder, Greer, SC (US)

Correspondence Address: Chris Comuntzis, Nixon & Vanderhye P.C., 8th Floor, 1100 North Glebe Road, Arlington, VA, 22201-4714, US

(21) Appl. No.: 09/792,633

(22) Filed: Feb. 23, 2001

(51) Int. Cl. F16L 25/00

(52) U.S. Cl. 285/330

(57) ABSTRACT

A compression fitting for use in, for example, gas turbines includes a sleeve and an integrally formed key disposed partially along the length of the sleeve, a compressor body, a receiver body that threadably engages with the compressor body, and a seal. The seal is compressed against wires or instrumentation lines that pass through the fitting from the interior to the exterior of the gas turbine. The one part construction of the sleeve and key facilitates assembly of the compression fitting into the gas turbine. The key prevents the sleeve from rotating during and after compression of the fitting thereby protecting the wires or instrumentation lines passing through the fitting from being damaged or sheared off.

### BACKGROUND OF THE INVENTION

This invention relates to compression fittings, and, more particularly, to an improved compression fitting which integrates two separate parts of the fitting into one part.

Conventional CONAX Buffalo fittings comprise a number of parts including, as shown in FIG. 1, compressor body 10, detachable round removable pin 12, cylindrical sleeve 14, which includes a groove into which pin 12 is fitted, insulators 16 and 18, seal 20 and receiver body 22. During assembly receiver body 22 partially threads into compressor body 10 with components 12 to 18 being disposed within the cavities of compressor body 10 and receiver body 22. Compressive force applied to compressor body 10 causes seal 20 to tighten down on instrumentation lines (not shown) passing through the fitting. The compressive force also causes pin 12 to prevent sleeve 14 from rotating. Thus, the fitting is used to create an airtight seal against the instrumentation lines passing from the interior to the exterior of industrial machinery.

Quite often pin 12 of the fitting becomes lost and the fitting is assembled without the missing pin being detected. Assembly of the fitting without pin 12 can cause severe damage to the instrumentation lines such as, for example, thermocouples used in gas turbines. Omission of pin 12 allows rotation of sleeve 14 which can shear off or severely damage the thermocouple wires. Such damage, usually identified either during factory test or in the field, causes shipment delays and increased costs.

### BRIEF SUMMARY OF THE INVENTION

The integration of the substantially round pin or key and the cylindrical sleeve of the fitting, reducing the number of parts from two to one, eliminates defects and streamlines the assembly process of a gas turbine. The integrated key serves the same purpose as the pin in the conventional fitting, namely, preventing rotation of the sleeve during assembly. Thermocouple wires, or the like, passing through the fitting must be sealed air tight to preclude the escape of, for example, lube oil through the fitting and yet at the same time not be crimped or sheared off as the compression fitting is assembled. Provision of the integrated key on the sleeve assures that rotation of the sleeve is prevented, thereby precluding damage or shearing off of the thermocouple wires as the airtight seal is made.

### BRIEF DESCRIPTION OF THE DRAWINGS

FIG. 1 is a drawing of a conventional CONAX Buffalo fitting.

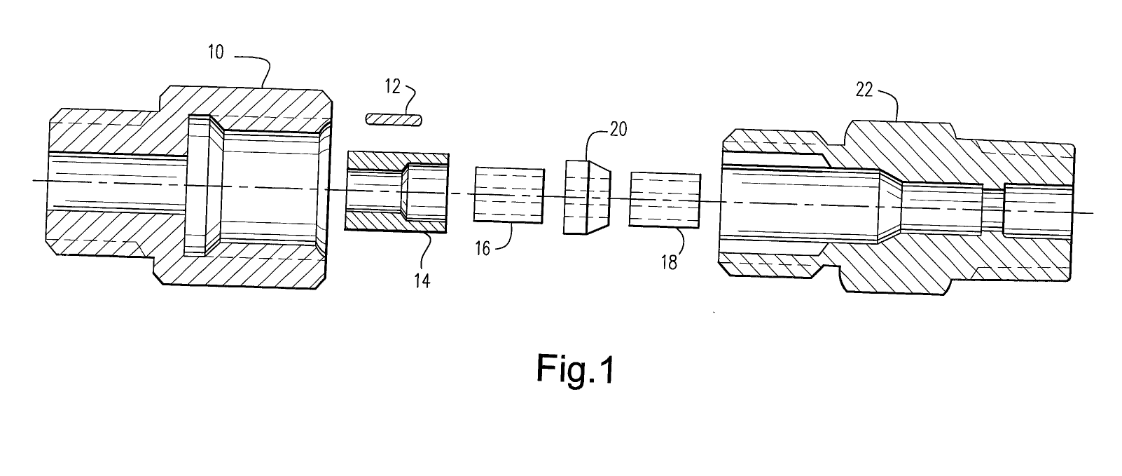

FIG. 2 is a perspective view of the present invention.

### DETAILED DESCRIPTION OF THE INVENTION

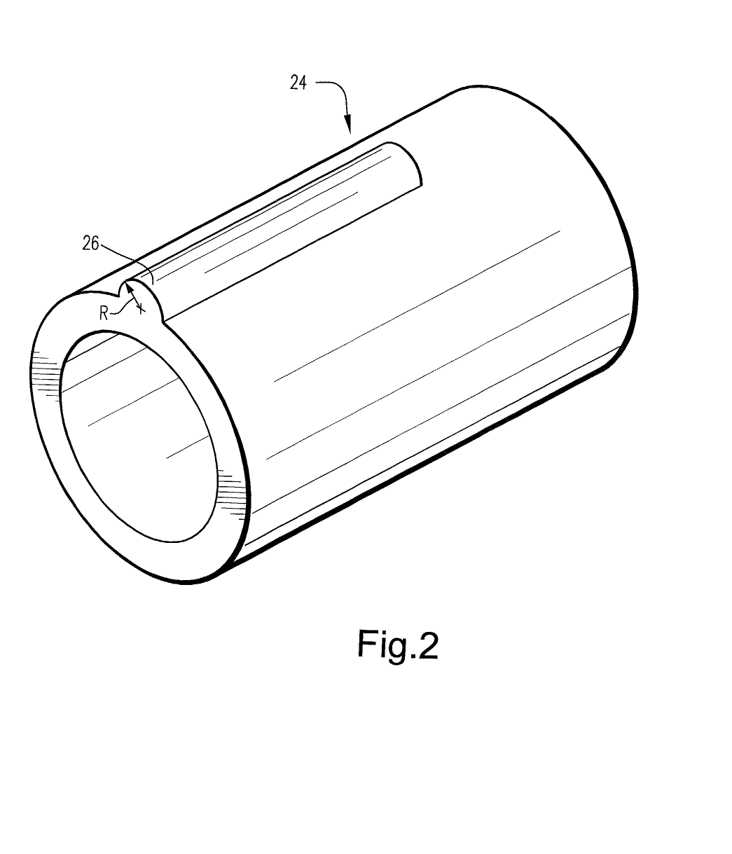

As shown in FIG. 2, cylindrical sleeve 24 has been integrally formed to include key 26 which substitutes for removable pin 12 in the conventional fitting. Key 26 is formed to have a rounded upper surface so as to simulate the profile of a pin recessed in a groove formed on the sleeve. The radius R of key 26 is preferably from 0.0620 inches to 0.0625 inches and the diameter of sleeve 24 is preferably 0.745 inches to 0.750 inches. Sleeve 24 and integrated key 26 can be made, for example, from AISI 303 or 304 stainless steel.

Three pilot tests were carried out at various torque loads. The maximum load applied was 250 ft-lbs, before the key of the sleeve slightly deformed. The test maximum load exceeded the recommended fitting load by 2.5 times, accordingly, the load at which deformation occurred will never be reached in the normal assembly process.

The optimal key position of 0.312″ from one end of the sleeve was determined from case studies using the two piece original design. The groove/pin position was looked at before and after compression. Marking the sleeve and the pin in before and after positions determined the 0.312″ dimension. When compressed, the invention actually has more key in the receiver than the original two piece design. Before compression, the sleeve of the present invention has approximately 0.100″ less key engaged than the original design. However, since the key is constantly engaging as the compression process takes place and the torque values start low and increase as the process progresses, this does not present a problem.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A compression fitting comprising a cylindrical sleeve and a key integrally formed on an outer surface of said sleeve; said key being provided to prevent rotation of the sleeve during and after compression of the compression fitting.

2. The compression fitting of claim 1, wherein said key is formed along a portion of the length of said cylindrical sleeve.

3. The compression fitting of claim 2, wherein said key is recessed 0.312 inches from one end of said cylindrical sleeve.

4. The compression fitting of claim 1, wherein said key has a rounded upper surface.

5. The compression fitting of claim 2, wherein said key has a rounded upper surface.

6. The compression fitting of claim 3, wherein said key has a rounded upper surface.

7. The compression fitting of claim 1, wherein said cylindrical sleeve and integrally formed key are made of any one of AISI 303 stainless steel and AISI 304 stainless steel.

8. The compression fitting of claim 2, wherein said cylindrical sleeve and integrally formed key are made of any one of AISI 303 stainless steel and AISI 304 stainless steel.

9. The compression fitting of claim 3, wherein said cylindrical sleeve and integrally formed key are made of any one of AISI 303 stainless steel and AISI 304 stainless steel.

10. The compression fitting of claim 4, wherein said cylindrical sleeve and integrally formed key are made of any one of AISI 303 stainless steel and AISI 304 stainless steel.

11. A compression fitting comprising:
a compressor body;
a receiver body which threads into said compressor body; and
a cylindrical sleeve having a key integrally formed on an outer surface of said sleeve, said cylindrical sleeve and key fitting within said compressor body and said receiver body, and said key being provided to prevent rotation of said cylindrical sleeve during and after compression force is applied to said compressor body.

12. The compression fitting of claim 11, further comprising a seal disposed within said compressor body and said receiver body, said seal being compressed against instrumentation lines passing through the compression fitting to form an airtight seal.

13. The compression fitting of claim 11, wherein said key is formed along a portion of the length of said cylindrical sleeve.

14. The compression fitting of claim 12, wherein said key is formed along a portion of the length of said cylindrical sleeve.

15. The compression fitting of claim 11, wherein said key is recessed 0.312 inches from one end of said cylindrical sleeve.

16. The compression fitting of claim 12, wherein said key is recessed 0.312 inches from one end of said cylindrical sleeve.

17. The compression fitting of claim 11, wherein said key has a rounded upper surface.

18. The compression fitting of claim 12, wherein said key has a rounded upper surface.

19. The compression fitting of claim 11, wherein said cylindrical sleeve and integrally formed key are made of any one of AISI 303 stainless steel and AISI 304 stainless steel.

20. The compression fitting of claim 12, wherein said cylindrical sleeve and integrally formed key are made of any one of AISI 303 stainless steel and AISI 304 stainless steel.
